(19) United States
(12) Patent Application Publication
(10) Pub. No.: US 2007/0003677 A1
(43) Pub. Date: Jan. 4, 2007

(54) Corn grain-flavouring method

(76) Inventor: Carlos Galceran Martorell, Sant Fruitos De Bages (ES)

Correspondence Address: Striker Striker & Stenby, 103 East Neck road, Huntington, NY, 11743, US

(21) Appl. No.: 10/572,688

(22) PCT Filed: Oct. 27, 2004
(86) PCT No.: PCT/ES04/00471

§ 371 Date: Mar. 21, 2006

(30) Foreign Application Priority Data
Nov. 7, 2003 (ES) P200302606

(51) Int. Cl. A23L 1/22; A23L 2/56

(52) U.S. Cl. 426/534

(57) ABSTRACT

The invention relates to a corn grain-flavouring method. The inventive method consists in creating a hypersaturated brine in a suitably-sized container, using a mixture of water and sodium chloride in suitable quantities in relation to the amount of corn to be treated. The corn grain is then introduced into the aforementioned brine and maintained thus for a period of time necessary in order for the corn to absorb all of the brine. Next, the corn is dried, by spreading same over perforated trays and applying hot air, until the original moisture level of the corn grains is obtained. Subsequently, once the corn has been dried, a surface coating is applied to the grain using a food fixative, such as, for example, a food lacquer and, finally, the corn is packaged.

### OBJECT OF THE INVENTION

The present invention relates to a corn grain-flavouring method intended for human consumption.

The main object of the invention is to achieve an optimal degree of salting for corn kernels with the subsequent effect on their flavour, as well as optionally incorporating any other supplementary food flavouring, whether it is salty or sweet.

The invention is therefore intended for the food industry.

### BACKGROUND OF THE INVENTION

As is well known, corn kernels, which are consumed either in their natural state or toasted, are included within the wide range of products usually consumed as a “snack”.

Corn kernels are normally marketed as a “salty” product with a strong flavour.

In order to achieve this flavouring of corn according to the intended use of the popcorn preparation, for example in the case of products intended to be prepared by means of microwaves, manufacturers currently mix the corn in sealed containers with butter, salt or flavouring agents, which makes the corn lose its natural qualities; other manufacturers add these flavouring agents after the corn has expanded, once it has become popcorn, also reducing the quality and durability of the product characteristics.

### DESCRIPTION OF THE INVENTION

The process proposed by the invention resolves the drawbacks set forth above, and the following operational steps are established therein for that purpose:
A predetermined amount of water, in accordance with the amount of corn kernels to be treated, is introduced in a container with a suitable capacity, and sodium chloride is incorporated to the foregoing, also in a suitable amount, so as to obtain hypersaturated brine.
The water-sodium chloride mixture is subjected to a stirring step to facilitate obtaining brine.
Corn kernels are introduced in the container after obtaining the brine.
The corn is kept in the brine for a time comprised between 8 and 20 hours at room temperature and under atmospheric pressure until the corn absorbs all the brine. The variability of the time for this operational step is determined by the type of corn kernels used, i.e. by the characteristics and origin of the corn, which also affect the amount of salt and water used.
Then a corn drying step is carried out, such that after it is taken out of said container it is spread out on perforated trays, through the perforations of which hot air passes, returning the corn kernels to their natural moisture level, which drying step is carried out for a time comprised between 1 to 2 hours according to the drying air temperature and the type of corn.
Any food flavour can also be incorporated during this drying process or in the prior step of swelling the corn.
Finally, and after drying the corn, the kernels are subjected to a surface coating step with a fixing agent for foods, such as food-grade shellac for example, to prevent the loss of the flavouring agents, which step could be carried out inside a rotating drum or in another similar element.
The product is finally packaged.

The possibility of drastically reducing the brine absorption step has been provided for by changing the room temperature and atmospheric pressure conditions mentioned above, specifically by using a pressurized container and/or by substantially increasing the temperature of the water, a shortening of the process which is obviously obtained at the expense of an increase in energy consumption.

### PRACTICAL EMBODIMENT OF THE INVENTION

Ninety liters of water and 25 kg of sodium chloride were introduced in a container with a 1000 liter capacity.

After stirring the mixture, hypersaturated brine was obtained after 12 hours.

Then 300 kg of corn kernels of the popping corn variety were introduced in the container.

The corn pulp had absorbed all the brine after 8 to 12 hours, said absorption being carried out at room temperature and under atmospheric pressure.

Then the corn was spread out on perforated trays for which hot air was supplied, specifically at a temperature of 48° C., drying the corn kernels after 60 minutes, the kernels returning to their original moisture level.

The dried corn was then introduced in a rotating drum in which food-grade shellac was applied as a fixing agent, as well as flavouring agents, and after 60 minutes the entire surface of the corn kernels was coated with said fixing agent.

The product was finally packaged, being suitable for consumption thereof.

It is therefore understood that the product starts off raw and finishes raw, treated so as to be used in any type of machine for its expansion, for example in microwaves, paella dishes, pans, hot air machines, etc.

Having sufficiently described the nature of the invention as well as a practical embodiment, it is stated for all effects and purposes that the described elements can be modified provided that this does not involve an alteration of the essential features of the invention which are claimed below.

1. A process for flavouring corn kernels, specifically corn kernels intended for human consumption, characterized in that the following operational steps are established therein:
A predetermined amount of water, in accordance with the amount of corn kernels to be treated, is introduced in a container with a suitable capacity, and sodium chloride is incorporated to the foregoing, also in a suitable amount, so as to obtain hypersaturated brine.
Corn kernels are introduced in the container after obtaining the brine.
The corn is kept in the brine for a time comprised between 8 and 20 hours at room temperature and under atmospheric pressure.
Then a corn drying step is carried out, after it is taken out of said container, by means of spreading it out on perforated trays and applying hot air for a time comprised between 1 to 2 hours until the corn kernels recover their original moisture level.
The corn kernels are subjected to a surface coating with a fixing agent for foods, such as food-grade shellac and flavouring agents for example.
The product is packaged.

2. A process for flavouring corn kernels according to claim 1, characterized in that the water-sodium chloride mixture can be subjected to a stirring step to facilitate obtaining brine.

3. A process for flavouring corn kernels according to claim 1, characterized in that the step of keeping the corn in the brine can be carried out under pressure and/or at a temperature substantially higher than room temperature in order to shorten the time of said step.

4. A process for flavouring corn kernels according to claim 1, characterized in that any food flavour can be incorporated to the corn either in the corn swelling step or in the drying step.
